(19) United States
(12) Patent Application Publication
(10) Pub. No.: US 2023/0232304 A1
(43) Pub. Date: Jul. 20, 2023

(54) MOBILITY BETWEEN NEW RADIO STANDALONE AND NON-STANDALONE MODES

(71) Applicant: QUALCOMM Incorporated, San Diego, CA (US)

(72) Inventors: Rohit MAHARANA, San Diego, CA (US); Jeongho SEO, San Diego, CA (US); Venkata Chaithanya ARLA, San Diego, CA (US); Mukeshkumar JAIN, San Diego, CA (US)

(21) Appl. No.: 17/580,494

(22) Filed: Jan. 20, 2022

(51) Int. Cl. H04W 36/32; H04W 36/08; H04W 36/00

(52) U.S. Cl. CPC H04W 36/32; H04W 36/08; H04W 36/0058; H04W 92/10

(57) ABSTRACT

This disclosure provides systems, methods and apparatuses for controlling user equipment (UE) functionality according to a second cell type bias mode, associated with the UE being within a coverage area of first and second cells of first and second cell types of a network. In some examples, the first cell type may operate in at least a first frequency band and according to a first communication mode and the second cell type may operate in at least a second frequency band and according to a second communication mode. The second cell type bias mode may correspond with a bias favoring the second cell type, the second communication mode, or combinations thereof.

### TECHNICAL FIELD

This disclosure relates to wireless communications, including mobility between New Radio (NR) standalone (SA) and non-standalone (NSA) modes.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications at a user equipment (UE). The method may include camping on or wirelessly connecting, via the UE, with a first cell of a first cell type of a network according to a first communication mode. The first cell type may operate in at least a first frequency band. The method may involve controlling the UE according to a second cell type bias mode, associated with an indication that the UE is within a coverage area of a second cell of a second cell type of the network. The second cell type may be operating in at least a second frequency band and according to a second communication mode. The second cell type bias mode may correspond with a bias favoring the second communication mode. In some examples, the UE may be camped on the first cell of the first cell type. In some such examples, the second cell type bias mode may involve biasing a cell reselection process to favor reselection of the second cell type. According to some examples, the UE may be wirelessly connected with the first cell. In some such examples, the second cell type bias mode may involve sending a request, via the interface system, to the network for connection with the second cell or the second cell type.

Another innovative aspect of the subject matter described in this disclosure can be implemented in an apparatus for wireless communications at a UE. In some examples, the apparatus may be, or may include, a UE. The UE may include an interface system and a control system coupled to the interface system. The control system may be configurable for wireless communication via a first cell type of a network according to a first communication mode. The first cell type may operate in at least a first frequency band. The control system may be configurable for wireless communication via a second cell type of the network according to a second communication mode. The second cell type may operate in at least a second frequency band. The control system may be configured to camp on or wirelessly connect with a first cell of the first cell type via the interface system. The control system may be configured to control the UE according to a second cell type bias mode, associated with an indication that the UE is within a coverage area of a second cell of the second cell type. The second cell type bias mode may correspond with a bias favoring the second communication mode. In some examples, the UE may be camped on the first cell of the first cell type. According to some such examples, the second cell type bias mode may involve biasing a cell reselection process to favor reselection of the second cell type. In some examples, the UE may be wirelessly connected with the first cell. According to some such examples, the second cell type preferred mode may involve sending a request, via the interface system, to the network for connection with the second cell or the second cell type.

Another innovative aspect of the subject matter described in this disclosure can be implemented in a non-transitory computer-readable medium storing code for wireless communications at a UE. The code may include instructions executable by a control system to control a UE to perform a method for wireless communication. The method may include camping on or wirelessly connecting, via the UE, with a first cell of a first cell type of a network according to a first communication mode. The first cell type may operate in at least a first frequency band. The method may involve controlling the UE according to a second cell type bias mode, associated with an indication that the UE is within a coverage area of a second cell of a second cell type of the network. The second cell type may be operating in at least a second frequency band and according to a second communication mode. The second cell type bias mode may correspond with a bias favoring the second communication mode. In some examples, the UE may be camped on the first cell of the first cell type. In some such examples, the second cell type bias mode may involve biasing a cell reselection process to favor reselection of the second cell type. According to some examples, the UE may be wirelessly connected with the first cell. In some such examples, the second cell type bias mode may involve sending a request, via the interface system, to the network for connection with the second cell or the second cell type.

One innovative aspect of the subject matter described in this disclosure can be implemented in a method for wireless communications at a network entity. In some examples, the network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The method may include receiving a signal associated with a UE connected with a first cell of a first cell type of a network according to a first communication mode. The first cell type may operate in at least a first frequency band. The signal may indicate a second frequency band of a second cell of a second cell type for wireless communication according to a second communication mode. The method may include causing a command to be transmitted to the UE to connect with the second cell according to the second communication mode. In some examples, the signal may be, or may include, an over-the-air (OTA) signal. According to some examples, the first communication mode may be a New Radio (NR) standalone (SA) mode and the second communication mode may be a Long Term Evolution (LTE) and NR non-standalone (NSA) mode.

Another innovative aspect of the subject matter described in this disclosure can be implemented in an apparatus for wireless communications at a network entity. In some implementations, the apparatus may be, or may include, a UE. The UE may include means for camping on or wirelessly connecting with a first cell of a first cell type of a network according to a first communication mode. The first cell type may operate in at least a first frequency band. The UE may include means for controlling the UE according to a second cell type bias mode, associated with an indication that the UE is within a coverage area of a second cell of a second cell type of the network. The second cell type may operate in at least a second frequency band and according to a second communication mode. The second cell type bias mode may correspond with a bias favoring the second communication mode.

Details of one or more implementations of the subject matter described in this disclosure are set forth in the accompanying drawings and the description below.

Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an example wireless communications system that supports mobility between new radio (NR) standalone (SA) and non-standalone (NSA) modes.

FIG. 2 illustrates another example of a wireless communications system that supports mobility between communication modes.

FIG. 3 illustrates an example process which may be performed, for example, by a user equipment (UE).

FIG. 4A illustrates an example of SA Option 1, in which the core network is an Evolved Packet Core (EPC) network and the base station (BS) is, or includes, an evolved NodeB (eNB).

FIG. 4B illustrates an example of SA Option 2, in which the core network is a 5G core (5GC) network and the BS is, or includes, a gNodeB (gNB).

FIG. 4C illustrates an example of SA Option 3, in which the core network is a 5GC network and the BS is, or includes, a next-generation eNB (ng-eNB).

FIGS. 5A, 5B and 5C illustrate different example deployment options for non-standalone (NSA) mode.

FIGS. 5D and 5E illustrate additional example deployment options for non-standalone (NSA) mode.

FIG. 6 illustrates an example process involving mobility between SA and NSA modes which may be performed, for example, by a UE.

FIG. 7 illustrates an example process involving mobility between SA and NSA modes which may be performed, for example, by a UE.

FIG. 8 illustrates another example process involving mobility between SA and NSA modes.

FIG. 9 illustrates an example process which may be performed by a network entity.

FIG. 10 illustrates a block diagram of an example apparatus that supports mobility between NR SA and NSA modes.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In some implementations, a network may deploy different cell types that provide wireless communication via different communication modes in the same coverage area. For example, a first cell type of the network may be configured to provide wireless communication according to a first communication mode (such as an NR standalone (SA) mode) and may operate in at least a first frequency band, which also may be referred to herein as FRE A second cell type may be configured to provide wireless communication according to a second communication mode (such as an LTE and NR non-standalone (NSA) mode) and may operate in at least a second frequency band, which also may be referred to herein as FR2. The first cell type may be an NR gNB cell type associated with the first communication mode and the second cell type may be an LTE evolved nodeB (eNB) cell type associated with the second communication mode. In some such examples, FR1 may be a relatively lower-frequency band than FR2 that provides relatively less bandwidth and relatively slower data transmission speeds than those provided by FR2. For example, in some instances a UE may be in idle mode and camped on an SA service that provides relatively slower data transmission speeds than those available from an NSA service in the same coverage area. However, according to previously-disclosed methods, devices and systems, the UE would remain camped on a cell providing the slower SA/FR1 service, or reselect another cell providing the slower SA/FR1 service, if the received signal strength of the FR1 signals were acceptable.

In some implementations of the present disclosure, the UE may be configured to operate in a second cell type bias mode, such as an LTE eNB cell bias mode. For example, when the UE is in idle mode, the second cell type bias mode may involve biasing a cell reselection process to favor reselection of the second cell type. In some examples, the UE may be configured to bias the cell reselection process by adding an offset for signal strength measurements of the second cell type, by subtracting an offset for signal strength measurements of the first cell type, by increasing a priority of the second cell type, or combinations thereof. When the UE is in connected mode according to the first communication mode, the second cell type bias mode may involve sending a request to the network for connection with the second cell or the second cell type. In some examples, the request may be associated with the UE receiving an indication that the FR2 channel condition is above a certain level during a connected mode measurement.

Particular implementations of the subject matter described in this disclosure can be implemented to realize one or more of the following potential advantages. Some disclosed methods may allow the UE to take advantage of higher data transmission speeds that are available via NSA mode and FR2 instead of being constrained to remain on SA mode and FR1, when the UE is in a location in which the coverage areas overlap. In some such examples, the UE may be enabled to use information available to the UE itself (such as current measured signal strength information of a serving cell and neighbor cell, user activities, user priorities, UE battery level, etc.) in order to ascertain whether to remain in SA mode or switch to NSA mode, instead of relying solely on instructions (such as cell reselection criteria) obtained from the network. In some instances, a UE may have a hardware limitation of supporting only certain frequency bands for communication via SA mode, but may support more frequency bands for communication via NSA mode. In some such instances, the UE may request to switch to NSA mode, or bias a cell reselection process to favor reselection of an LTE eNB anchor cell, when appropriate.

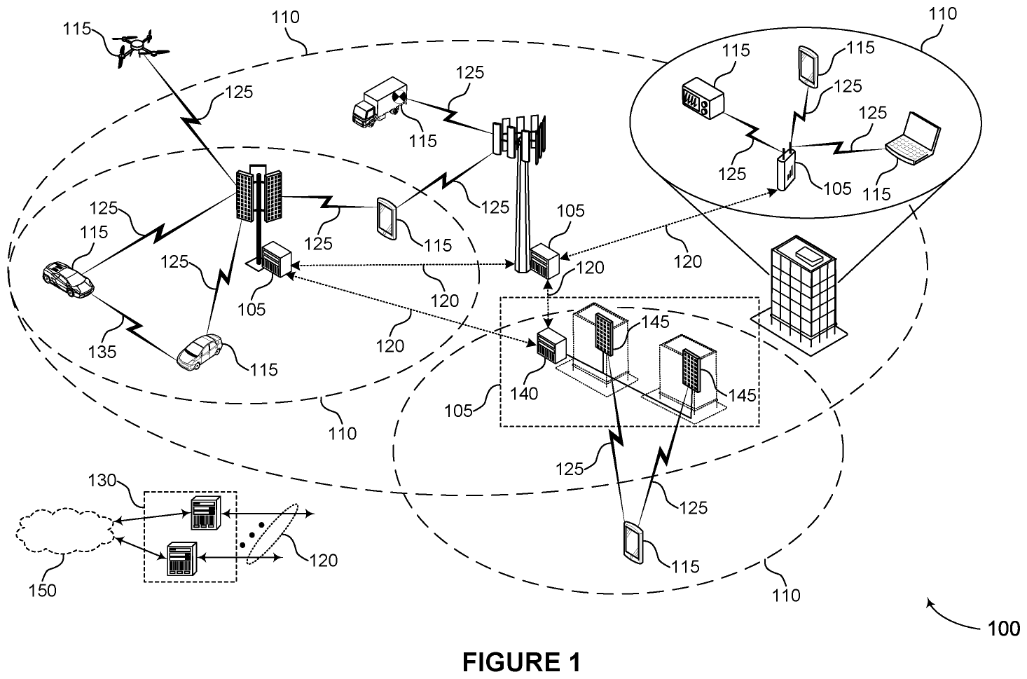

FIG. 1 illustrates an example wireless communications system 100 that supports mobility between NR SA and NSA modes. The wireless communications system 100 may include one or more base stations (BSs) 105, one or more UEs 115, and a core network 130. In some implementations, the wireless communications system 100 may be a Long Term Evolution (LTE) network, an LTE-Advanced (LTE-A) network, an LTE-A Pro network, or a New Radio (NR) network. In some implementations, the wireless communications system 100 may support enhanced broadband communications, ultra-reliable (for example, mission critical) communications, low latency communications, communications with low-cost and low-complexity devices, or any combination thereof.

The BSs 105 may be dispersed throughout a geographic area to form the wireless communications system 100 and may be devices in different forms or having different capabilities. The BSs 105 and the UEs 115 may wirelessly communicate via one or more communication links 125. Each BS 105 may provide a geographic coverage area 110 over which the UEs 115 and the BS 105 may establish one or more communication links 125. The geographic coverage area 110 may be an example of a geographic area over which a BS 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the BSs 105, or network equipment (for example, core network nodes, relay devices, integrated access and backhaul (IAB) nodes, or other network equipment), as shown in FIG. 1.

The BSs 105 may communicate with the core network 130, or with one another, or both. For example, the BSs 105 may interface with the core network 130 through one or more backhaul links 120 (for example, via an S1, N2, N3, or another interface). The BSs 105 may communicate with one another over the backhaul links 120 (for example, via an X2, Xn, or another interface) either directly (for example, directly between BSs 105), or indirectly (for example, via core network 130), or both. In some implementations, the backhaul links 120 may be or include one or more wireless links.

One or more of the BSs 105 described herein may include or may be referred to by a person having ordinary skill in the art as a base transceiver station, a radio BS, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other implementations.

The UEs 115 described herein may be able to communicate with various types of devices, such as other UEs 115 that may sometimes act as relays as well as the BSs 105 and the network equipment including macro eNBs or gNBs, small cell eNBs or gNBs, or relay BSs, among other implementations, as shown in FIG. 1.

The UEs 115 and the BSs 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation (CA) or multi-carrier operation. A UE 115 may be configured with multiple downlink component carriers and one or more uplink component carriers according to a CA configuration. CA may be used with both frequency division duplexing (FDD) and time division duplexing (TDD) component carriers.

In some implementations (for example, in a CA configuration), a carrier also may have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone (SA) mode where initial acquisition and connection may be conducted by the UEs 115 via the carrier, or the carrier may be operated in a non-standalone (NSA) mode where a connection is anchored using a different carrier (for example, of the same or a different radio access technology).

The communication links 125 shown in the wireless communications system 100 may include uplink transmissions from a UE 115 to a BS 105, or downlink transmissions from a BS 105 to a UE 115. Carriers may carry downlink or uplink communications (for example, in an FDD mode) or may be configured to carry downlink and uplink communications (for example, in a TDD mode).

A carrier may be associated with a particular bandwidth of the radio frequency spectrum, and in some implementations the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, the BSs 105, the UEs 115, or both) may have hardware configurations that support communications over a particular carrier bandwidth or may be configurable to support communications over one of a set of carrier bandwidths. In some implementations, the wireless communications system 100 may include BSs 105 or UEs 115 that support simultaneous communications via carriers associated with multiple carrier bandwidths. In some implementations, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (for example, a duration of one modulation symbol) and one subcarrier, where the symbol period and subcarrier spacing are inversely related. The quantity of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the BSs 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some implementations, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some implementations, the TTI duration (for example, the number of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

Each BS 105 may provide communication coverage via one or more cells, for example a macro cell, a small cell, a hot spot, or other types of cells, or any combination thereof. The term “cell” may refer to a logical communication entity used for communication with a BS 105 (for example, over a carrier) and may be associated with an identifier for distinguishing neighboring cells (for example, a physical cell identifier (PCID), a virtual cell identifier (VCID), or others). In some implementations, a cell also may refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the BS 105. For example, a cell may be or include a building, a subset of a building, or exterior spaces between or overlapping with geographic coverage areas 110, among other implementations.

A macro cell generally covers a relatively large geographic area (for example, several kilometers in radius) and may allow unrestricted access by the UEs 115 with service subscriptions with the network provider supporting the macro cell. A small cell may be associated with a lower-powered BS 105, as compared with a macro cell, and a small cell may operate in the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A BS 105 may support one or multiple cells and also may support communications over the one or more cells using one or multiple component carriers.

In some implementations, a carrier may support multiple cells, and different cells may be configured according to different protocol types (for example, MTC, narrowband IoT (NB-IoT), enhanced mobile broadband (eMBB)) that may provide access for different types of devices.

In some implementations, a BS 105 may be movable and therefore provide communication coverage for a moving geographic coverage area 110. In some implementations, different geographic coverage areas 110 associated with different technologies may overlap, but the different geographic coverage areas 110 may be supported by the same BS 105. In some other implementations, the overlapping geographic coverage areas 110 associated with different technologies may be supported by different BSs 105. The wireless communications system 100 may include, for example, a heterogeneous network in which different types of the BSs 105 provide coverage for various geographic coverage areas 110 using the same or different radio access technologies.

The wireless communications system 100 may support synchronous or asynchronous operation. For synchronous operation, the BSs 105 may have similar frame timings, and transmissions from different BSs 105 may be approximately aligned in time. For asynchronous operation, the BSs 105 may have different frame timings, and transmissions from different BSs 105 may, in some implementations, not be aligned in time. The techniques described herein may be used for either synchronous or asynchronous operations.

Some UEs 115 may be configured to employ operating modes that reduce power consumption, such as half-duplex communications (for example, a mode that supports one-way communication via transmission or reception, but not transmission and reception simultaneously). In some implementations, half-duplex communications may be performed at a reduced peak rate. Other power conservation techniques for the UEs 115 include entering a power saving deep sleep mode when not engaging in active communications, operating over a limited bandwidth (for example, according to narrowband communications), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some implementations, a UE 115 also may be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a BS 105. Other UEs 115 in such a group may be outside the geographic coverage area 110 of a BS 105 or be otherwise unable to receive transmissions from a BS 105. In some implementations, groups of the UEs 115 communicating via D2D communications may utilize a one-to-many (1:M) system in which each UE 115 transmits to every other UE 115 in the group. In some implementations, a BS 105 facilitates the scheduling of resources for D2D communications. In some other implementations, D2D communications are carried out between the UEs 115 without the involvement of a BS 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the BSs 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a BS 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or BS 105 may be distributed across various network devices (for example, radio heads and ANCs) or consolidated into a single network device (for example, a BS 105). In various implementations, a BS 105, or an access network entity 140, or a core network 130, or some subcomponent thereof, may be referred to as a network entity.

As described herein, a BS 105 may include components that are located at a single physical location or components located at various physical locations. In examples in which the BS 105 includes components that are located at various physical locations, the various components may each perform various functions such that, collectively, the various components achieve functionality that is similar to a BS 105 that is located at a single physical location. As such, a BS 105 described herein may equivalently refer to a standalone BS 105 or a BS 105 including components that are located at various physical locations or virtualized locations. In some implementations, such a BS 105 including components that are located at various physical locations may be referred to as or may be associated with a disaggregated radio access network (RAN) architecture, such as an Open RAN (O-RAN), Distributed RAN (D-RAN), or Virtualized RAN (VRAN) architecture. In some implementations, such components of a BS 105 may include or refer to one or more of a central unit (CU), a distributed unit (DU), or a radio unit (RU).

The wireless communications system 100 may operate using one or more frequency bands, sometimes in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the lower frequencies and longer waves of the high frequency (HF) or very high frequency (VHF) portion of the spectrum below 300 MHz.

The wireless communications system 100 also may operate in a super high frequency (SHF) region using frequency bands from 3 GHz to 30 GHz, also known as the centimeter band, or in an extremely high frequency (EHF) region of the spectrum (for example, from 30 GHz to 300 GHz), also known as the millimeter band. In some implementations, the wireless communications system 100 may support millimeter wave (mmW) communications between the UEs 115 and the BSs 105, and EHF antennas of the respective devices may be smaller and more closely spaced than UHF antennas. In some implementations, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

In some instances, a UE 115 may be in a location in which the UE 115 is within a coverage area of two or more BSs 105. In some instances, the UE 115 may be within a coverage area of a first BS 105 that is operating according to a first communication mode (such as an SA mode) in at least a first frequency band, such as a frequency band in the UHF region. In some such examples, the UE 115 may be within a coverage area of a second BS 105 that is operating according to a second communication mode (such as an NSA mode) in at least a second frequency band, such as a frequency band in the EHF region or the SHF region. For example, the UE 115 may be connected with the BS 105 that is operating in the UHF region while a user of the UE 115 is watching a video on the UE 115. The second frequency band of the second BS 105 may, in some instances, have greater bandwidth than the first frequency band and may be capable of providing higher data speeds and a better user experience for the user of the UE 115. With previously-disclosed methods, devices and systems, the network would generally cause UE 115 to remain connected to the first BS 105 as long as the signals received from the first BS 105 and measured by the UE 115 were at an acceptable level, even if it would be advantageous for the UE 115 to establish a connection with the second BS 105. Some disclosed methods, devices and systems allow the UE 115 to send a request to the network to establish a connection with the second BS 105 according to the second communication mode.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the BSs 105 and the UEs 115 may employ carrier sensing for collision detection and avoidance. In some implementations, operations in unlicensed bands may be based on or associated with a CA configuration in conjunction with component carriers operating in a licensed band (for example, LAA). Operations in unlicensed spectrum may include downlink transmissions, uplink transmissions, P2P transmissions, or D2D transmissions, among other transmissions.

A BS 105 or a UE 115 may be equipped with multiple antennas, which may be used to employ techniques such as transmit diversity, receive diversity, multiple-input multiple-output (MIMO) communications, or beamforming. The antennas of a BS 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a BS 105 may be located in diverse geographic locations. A BS 105 may have an antenna array with a number of rows and columns of antenna ports that the BS 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The BSs 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which also may be referred to as spatial filtering, directional transmission, or directional reception, is a signal processing technique that may be used at a transmitting device or a receiving device (for example, a BS 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A BS 105 or a UE 115 may use beam sweeping techniques as part of beam forming operations. For example, a BS 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a BS 105 multiple times in different directions. For example, the BS 105 may transmit a signal according to different beamforming weight sets associated with different directions of transmission. Transmissions in different beam directions may be used to identify (for example, by a transmitting device, such as a BS 105, or by a receiving device, such as a UE 115) a beam direction for later transmission or reception by the BS 105.

Some signals, such as data signals associated with a particular receiving device, may be transmitted by a BS 105 in a single beam direction (for example, a direction associated with the receiving device, such as a UE 115). In some implementations, the beam direction associated with transmissions along a single beam direction may be determined based on or in accordance with a signal that was transmitted in one or more beam directions. For example, a UE 115 may receive one or more of the signals transmitted by the BS 105 in different directions and may report to the BS 105 an indication of the signal that the UE 115 received with a highest signal quality or an otherwise acceptable signal quality.

In some implementations, transmissions by a device (for example, by a BS 105 or a UE 115) may be performed using multiple beam directions, and the device may use a combination of digital precoding or radio frequency beamforming to generate a combined beam for transmission (for example, from a BS 105 to a UE 115). The UE 115 may report feedback that indicates precoding weights for one or more beam directions, and the feedback may correspond to a configured number of beams across a system bandwidth or one or more sub-bands. The BS 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a BS 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) when receiving various signals from the BS 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (for example, when receiving a data signal). The single receive configuration may be aligned in a beam direction determined based on or in accordance with listening according to different receive configuration directions (for example, a beam direction determined to have a highest signal strength, highest signal-to-noise ratio (SNR), or otherwise acceptable signal quality based on or in accordance with listening according to multiple beam directions).

The UEs 115 and the BSs 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the medium access control (MAC) layer in poor radio conditions (for example, low signal-to-noise conditions). In some implementations, a device may support same-slot HARQ feedback, where the device may provide HARQ feedback in a specific slot for data received in a previous symbol in the slot. In some other implementations, the device may provide HARQ feedback in a subsequent slot, or according to some other time interval.

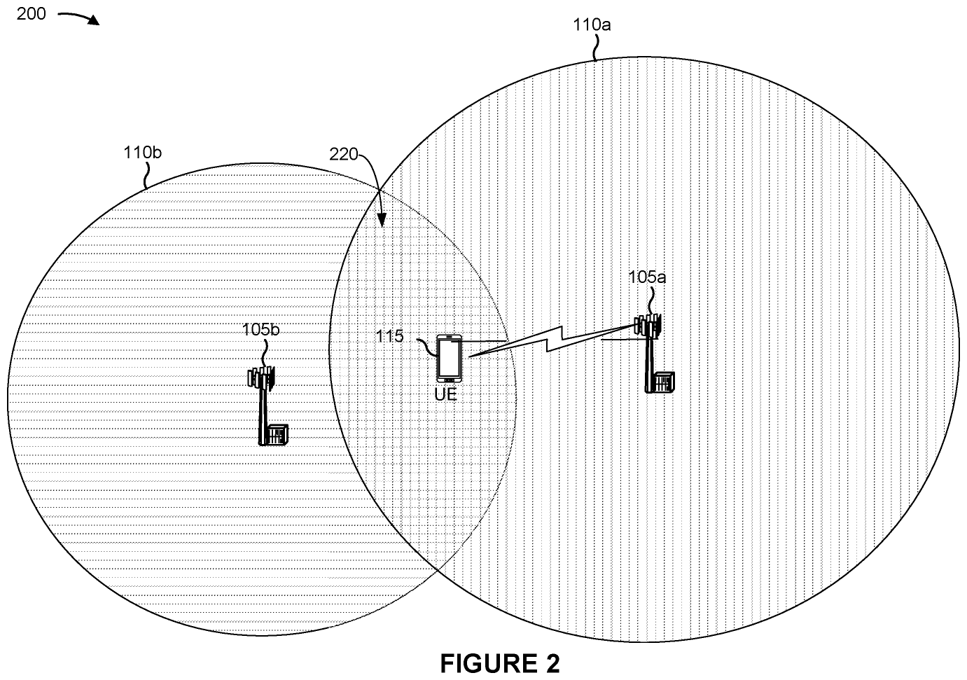

FIG. 2 illustrates another example of a wireless communications system that supports mobility between communication modes. In this example, the wireless communications system 200 includes different cell types that provide wireless communication via different communication modes in the same coverage area. According to this example, the wireless communications system 200 includes at least a BS 105a, which is configured to provide wireless communication according to a first communication mode, and a BS 105b, which is configured to provide wireless communication according to a second communication mode. In this example, the BS 105b is a different cell type from that of the BS 105a. According to this example, the BS 105a is configured to operate in at least a first frequency band, which may be referred to herein as FR1, and the BS 105b is configured to operate in at least a second frequency band, which may be referred to herein as FR2. In some examples, the second frequency band may include a higher range of frequencies than the frequencies of the first frequency band. In some such examples, the second frequency band may provide greater data speeds than the first frequency band.

According to this example, the BS 105a has a coverage area 110a (which also may be referred to herein as an FR1 coverage area) and the BS 105b has a coverage area 110b (which also may be referred to herein as an FR2 coverage area). In this example, the UE 115 is located in an area 220, in which the geographic coverage areas 110 and 110b overlap.

In this example, the UE 115 has established wireless communication with the BS 105a according to the first communication mode. In some instances, the UE 115 may be camped on the BS 105a according to an idle mode state of the first communication mode, whereas in other instances the UE 115 may communicate with the BS 105a according to a connected mode state of the first communication mode, such as when the UE 115 has initiated a data call. In this example, the UE 115 is configured to detect and measure signals from the BS 105b while in wireless communication with the BS 105a, whether the UE 115 is in idle mode or in connected mode. In other examples, the UE 115 may be camped on the BS 105b according to the second communication mode.

In some implementations of the present disclosure, the UE 115 may be configured to operate in a second cell type bias mode. For example, when the UE is in an idle mode state of the first communication mode and in wireless communication with the BS 105a, the second cell type bias mode may involve biasing a cell reselection process to favor reselection of the second cell type, biasing a cell reselection process to favor the second communication mode, or a combination thereof. In some examples, the UE may be configured to bias the cell reselection process by adding an offset for signal strength measurements of the second cell type, by subtracting an offset for signal strength measurements of the first cell type, by increasing a priority of the second cell type, or combinations thereof.

When the UE is in connected mode according to the first communication mode, the second cell type bias mode may involve sending a request to the network for connection with the second cell or the second cell type. In some instances, the request may be associated with the UE receiving an indication that the FR2 channel condition is above a certain level during a connected mode signal strength measurement.

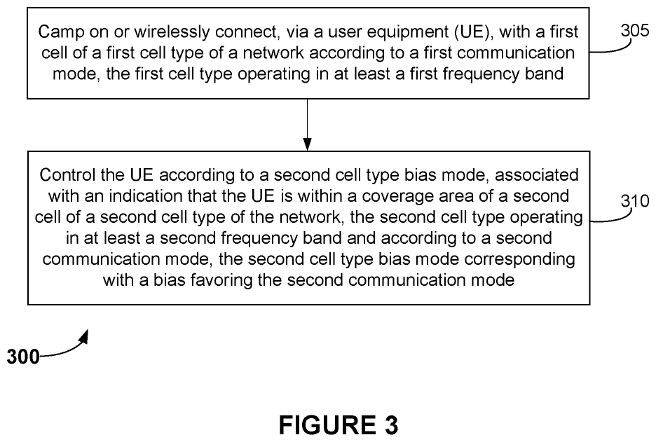

FIG. 3 is a diagram illustrating an example process 300 which may be performed, for example, by a UE. In some such examples, the process 300 may be performed by a UE 115 such as one of those disclosed herein. Although FIG. 3 shows example blocks of the process 300, in some aspects, the process 300 may include additional blocks, fewer blocks, different blocks, or differently arranged blocks than those depicted in FIG. 3. Additionally, or alternatively, in some examples two or more of the blocks of the process 300 may be performed in parallel. The process 300 may include additional aspects, such as any single aspect or any combination of aspects described herein or in connection with one or more other processes described elsewhere herein.

According to this example, block 305 involves camping on or wirelessly connecting, via a user equipment (UE), with a first cell of a first cell type of a network according to a first communication mode. In this example, the first cell type is operating in at least a first frequency band. In some instances, block 305 may involve the UE 115 of FIG. 2 being in wireless communication with the BS 105a according to the first communication mode.

In this example, block 310 involves controlling the UE according to a second cell type bias mode, associated with an indication that the UE is within a coverage area of a second cell of a second cell type of the network. According to this example, the second cell type is operating in at least a second frequency band and according to a second communication mode. In this example, the second cell type bias mode corresponds with a bias favoring the second communication mode.

For example, block 310 may involve controlling the UE 115 of FIG. 2 according to a second cell type bias mode, associated with an indication that the UE is within a coverage area of a second cell of a second cell type, an indication that the UE is within the coverage area 110b of the BS 105b. As noted elsewhere herein, the BS 105b is a different cell type from that of the BS 105a and operates in a second frequency band according to a second communication mode.

In some instances, the UE may be camped on the first cell of the first cell type. For example, camping on the first cell may correspond to an idle mode state of the UE according to the first communication mode. In some such examples, the second cell type bias mode may involve biasing a cell reselection process to favor reselection of the second cell type. In some such examples, biasing the cell reselection process may involve increasing a priority of the second cell type. Alternatively, or additionally, biasing the cell reselection process may involve adding an offset to signal strength measurements of the second cell type, subtracting an offset to signal strength measurements of the first cell type, or a combination thereof. In some examples, process 300 may involve reselecting the second cell according to the cell reselection process.

In some instances, the UE may be wirelessly connected with the first cell. For example, the UE may be communicating with the first cell according to a connected state according to the first communication mode.

In some implementations, the first communication mode may be an NR standalone (SA) mode. In some such examples, FR1 may be a frequency band within a frequency range of 410 MHz-7125 MHz. According to some such implementations, the BS 105a may be an NR gNB cell type associated with the first communication mode using the first frequency band. However, SA mode has various deployment options.

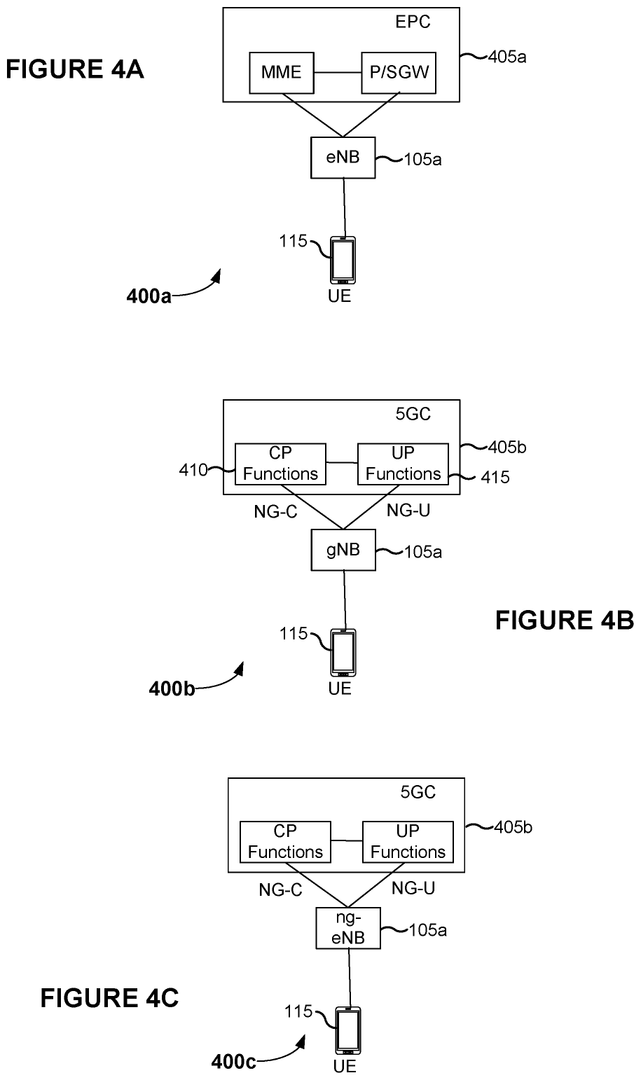

FIG. 4A shows an example of SA Option 1, in which the core network 130a is an Evolved Packet Core (EPC) network and the BS 105c is, or includes, an eNB. One or more components of the core network 130a may be an example of one or more components of the core network 130, such as illustrated by and described with reference to FIG. 1. One or more components of the BS 105c may be an example of one or more components of a BS 105, such as illustrated by and described with reference to FIG. 1, or an example of one or more components of a BS 105a or a BS 105b, such as illustrated by and described with reference to FIG. 2. In this example, the core network 130a of the wireless communications system 400a includes a mobility management entity (MME) 405, which is configured to manage UE network access and mobility, as well as to establish the bearer path for UEs. According to this example, the MME 405 is also configured to control mobility between LTE and other networks. In this example, the core network 130a includes a serving gateway (SGW) and a Packet Data Network (PDN) gateway, which are shown in FIG. 4A as P/SGW 407. The SGW may be configured to route and forward user data packets. The SGW of the P/SGW 407 also may be configured for inter-eNB handovers in the user plane (UP) and for providing mobility between LTE and other types of networks. The PDN gateway of the P/SGW 407 may be configured to provide connectivity from the UE 115 to external PDNs by being the point of exit and entry of traffic for the UE 115. One or more components of the UE 115 may be an example of one or more components of a UE 115, such as illustrated by and described with reference to FIGS. 1 and 2.

FIG. 4B shows an example of SA Option 2, in which the core network 130b of the wireless communications system 400b is a 5G core (5GC) network and the BS 105d is, or includes, a gNB. One or more components of the core network 130b may be an example of one or more components of the core network 130, such as illustrated by and described with reference to FIG. 1. One or more components of the BS 105d may be an example of one or more components of a BS 105, such as illustrated by and described with reference to FIG. 1, or an example of one or more components of a BS 105a or a BS 105b, such as illustrated by and described with reference to FIG. 2. One or more components of the UE 115 shown in FIG. 4B may be an example of one or more components of a UE 115, such as illustrated by and described with reference to FIG. 1, 2 or 4A. In this example, a simplified version of the 5GC is shown, which includes control plane (CP) function providers 410 and user plane (UP) function providers 415. The CP function providers 410 may include access and mobility function (AMF) providers, authentication service function (AUSF) providers, session management function (SMF) providers, etc. The UP function providers 415 may be configured to provide connectivity to one or more data networks, to route and forward user data packets, etc. In some examples, the CP function providers 410 and UP function providers 415 may be provided via network function virtualization (NFV). The 5G network may provide software-defined networking (SDN), network slicing, multi-access edge computing (MEC), or combinations thereof. In this example, the gNB communicates via a next-generation (NG) control plane interface (NG-C) with the 5GC CP function providers 410 and communicates via an NG user plane interface (NG-U) with the 5GC UP function providers 415.

FIG. 4C shows an example of SA Option 3, in which the core network 130b of the wireless communications system 400C is a 5GC network and the BS 105e is, or includes, a next-generation eNB (ng-eNB). In this example, the components of the core network 130b (including the CP function providers 410 and UP function providers 415) are examples of the components of the core network 130b as described with reference to FIG. 4B. One or more components of the BS 105e may be an example of one or more components of a BS 105, such as illustrated by and described with reference to FIG. 1, or an example of one or more components of a BS 105a or a BS 105b, such as illustrated by and described with reference to FIG. 2. One or more components of the UE 115 shown in FIG. 4C may be an example of one or more components of a UE 115, such as illustrated by and described with reference to FIGS. 1, 2, 4A and 4B. An ng-eNB is a node providing Evolved Universal Terrestrial Radio Access (E-UTRA) user plane and control plane protocol terminations towards the UE 115. In this example, the ng-eNB communicates via a next-generation (NG) control plane interface (NG-C) with the 5GC CP function providers 410 and communicates via an NG user plane interface (NG-U) with the 5GC UP function providers 415.

According to some implementations, the second communication mode may be a non-standalone (NSA) mode. In some such examples, FR2 may be a frequency band within a frequency range of 24250 MHz-52600 MHz. In some examples, a BS 105 (such as the BS 105b of FIG. 2) may be an LTE evolved nodeB (eNB) cell type associated with the second communication mode using the second frequency band. According to some such implementations, the second communication mode may be an LTE and NR non-standalone (NSA) mode. In some such examples, the BS 105b may be an LTE eNB anchor cell. However, NSA mode has various deployment options.

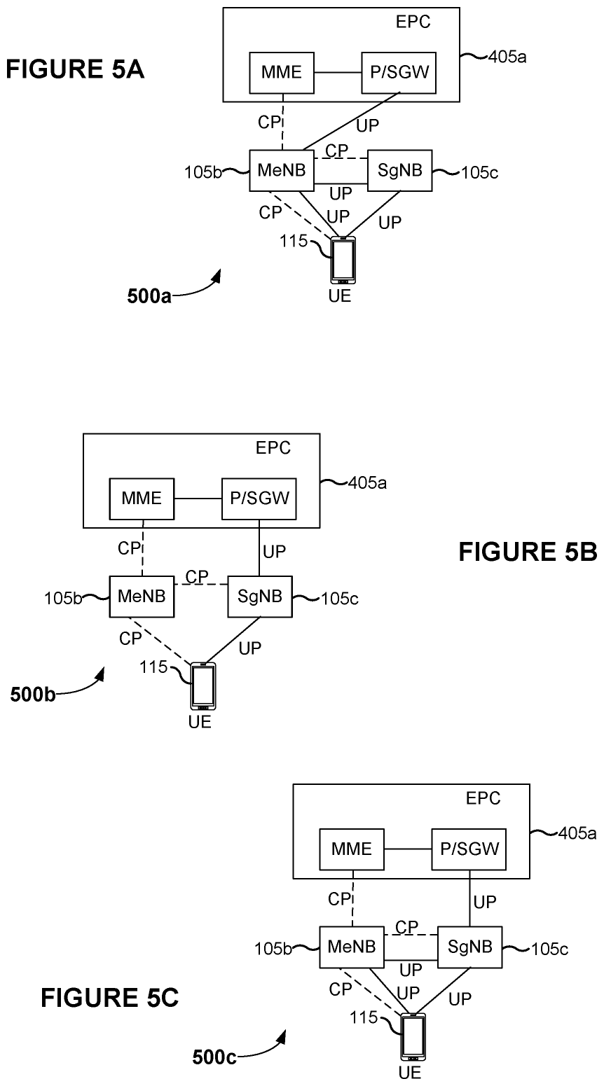

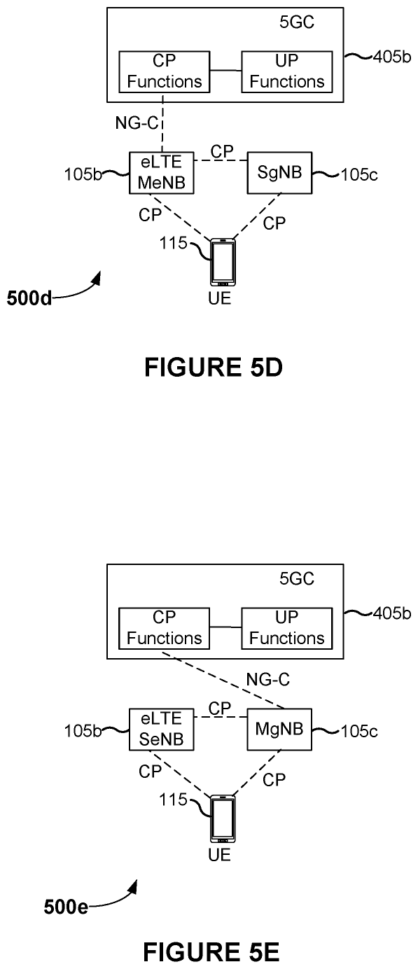

FIGS. 5A, 5B and 5C show different deployment options for non-standalone (NSA) mode. FIGS. 5A, 5B and 5C each include a UE 115, a BS 105f, a BS 105g and an instance of the core network 130a shown in FIG. 4A. One or more components of the UE 115 may be an example of one or more components of a UE 115, such as illustrated by and described with reference to FIG. 1, 2 or 4A-4C. One or more components of the BS 105f and the BS 105g may be an example of one or more components of a BS 105, such as illustrated by and described with reference to FIG. 1, or an example of one or more components of a BS 105a or a BS 105b, such as illustrated by and described with reference to FIG. 2. In some such examples, the BS 105f may be an instance of the BS 105b, such as illustrated by and described with reference to FIG. 2 or an instance of the BS 105c, such as illustrated by and described with reference to FIG. 4A. In some such implementations, the BS 105g may be an instance of the BS 105a, such as illustrated by and described with reference to FIG. 2 or an instance of the BS 105d, such as illustrated by and described with reference to FIG. 4B. In all three of these examples, the BS 105f is an eNB anchor cell (MeNB). In these examples, the BS 105g is a secondary gNB (SgNB). In the examples shown in FIGS. 5A, 5B and 5C, all control plane (CP) signaling goes through the MeNB. Other examples may include different elements, different arrangements of elements, or combinations thereof.

FIG. 5A corresponds to NSA Option 3. Accordingly, wireless communications system 500a of FIG. 5A shows an anchor cell split bearer example, in which the SgNB is not directly connected to the core network 130a. Therefore, all of the user plane (UP) signaling also passes through the MeNB.

FIG. 5B corresponds to NSA Option 3a. Accordingly, wireless communications system 500b of FIG. 5B shows a secondary cell group (SCG) bearer example in which the SgNB controls UP signaling between the UE 115 and the core network 130a.

FIG. 5C corresponds to NSA Option 3x. Accordingly, wireless communications system 500c of FIG. 5C shows an SCG split bearer example, in which the SgNB controls UP signaling between the UE 115 and the core network 130a, as well as UP signaling involving the MeNB.

FIGS. 5D and 5E show additional deployment options for non-standalone

(NSA) mode. FIGS. 5D and 5E each include a UE 115, a BS 105h, a BS 105i and an instance of the BS 105b of FIG. 2, as well as an instance of the core network 130b shown in FIGS. 4B and 4C. One or more components of the UE 115 may be an example of one or more components of a UE 115, such as illustrated by and described with reference to FIG. 1, 2 or 4A-5C. One or more components of the BS 105h and the BS 105i may be an example of one or more components of a BS 105, such as illustrated by and described with reference to FIG. 1, or an example of one or more components of a BS 105a or a BS 105b, such as illustrated by and described with reference to FIG. 2. In some such examples, the BS 105h may be an instance of the BS 105b, such as illustrated by and described with reference to FIG. 2. In these examples, the BS 105h is, or includes, an eLTE eNB, which is an evolved eNB that can support connectivity to an EPC as well as to a SGC. According to these examples, the BS 105i is, or includes, a gNB. In some implementations, the BS 105i may be an instance of the BS 105a, such as illustrated by and described with reference to FIG. 2, an instance of the BS 105d, such as illustrated by and described with reference to FIG. 4B, or an instance of the BS 105g, such as illustrated by and described with reference to FIGS. 5A-5C. For the sake of simplicity, only control plane (CP) signaling is shown in FIGS. 5D and 5E. Other examples may include different elements, different arrangements of elements, or combinations thereof.

FIG. 5D corresponds to NSA Options 7, 7a and 7x. Accordingly, wireless communications system 500d of FIG. 5D shows an example in which the eLTE eNB is an anchor eNB (MeNB). In this example, the SgNB is not directly connected to the core network 130b for CP signaling. Therefore, all of the CP signaling passes through the MeNB.

FIG. 5E corresponds to NSA Options 4 and 4a. Accordingly, wireless communications system 500e of FIG. 5E shows an example in which the eLTE eNB is a secondary eNB (SeNB) and the gNB is an anchor gNB (MgNB). In this example, the MgNB controls CP signaling between the UE 115, the SeNB and the core network 130b.

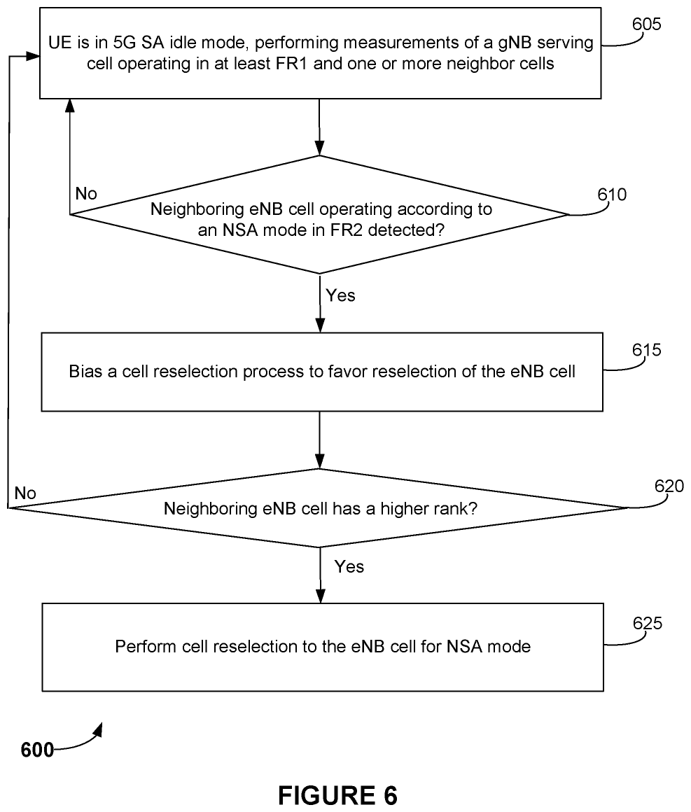

FIG. 6 is a diagram illustrating an example process 600 involving mobility between SA and NSA modes which may be performed, for example, by a UE. In some such examples, the process 600 may be performed by a UE 115 such as one of those disclosed herein. One or more components of the UE 115 may be an example of one or more components of a UE 115, such as illustrated by and described with reference to FIG. 1, 2 or 4A-5E. Although FIG. 6 shows example blocks of the process 600, in some aspects, the process 600 may include additional blocks, fewer blocks, different blocks, or differently arranged blocks than those depicted in FIG. 6. Additionally, or alternatively, in some examples, two or more of the blocks of the process 600 may be performed in parallel. The process 600 may include additional aspects, such as any single aspect or any combination of aspects described herein or in connection with one or more other processes described elsewhere herein.

According to this example, in block 605, the UE is in a 5G SA idle mode, performing measurements of a serving cell operating in at least a first frequency band, FRE In this example, the serving cell is a gNB cell, for example as described herein with reference to FIG. 4B. However, in some other examples, the serving cell may be another type of serving cell, such as described herein with reference to FIG. 4C. According to the example in block 605, the UE is performing measurements of one or more neighbor cells.

In this example, block 610 involves receiving an indication of whether a neighboring cell (in this particular example, a neighboring eNB cell) is operating according to an NSA mode in at least a second frequency band, FR2. In this implementation, if the UE receives an indication in block 610 that no neighboring cell is operating according to an NSA mode in at least FR2, the process 600 reverts to block 605. However, if the UE receives an indication in block 610 that a neighboring eNB cell is operating according to an NSA mode in at least FR2, the process 600 continues to block 615. In some examples, block 610 (or another block of process 600) also may involve receives an indication of whether the FR2 signals have an acceptable signal strength level.

According to this example, block 615 involves biasing a cell reselection process to favor reselection of the neighboring eNB cell. In some implementations, block 615 may involve increasing a priority of an eNB cell type. According to some examples, block 615 may involve increasing a priority of NSA mode. In some implementations, block 615 may involve adding an offset for signal strength measurements of the neighboring eNB cell. According to some examples, block 615 may involve subtracting an offset for signal strength measurements of the gNB serving cell.

In this example, block 620 involves ascertaining whether the neighboring eNB cell has a higher rank than the gNB serving cell. If so, in block 625 the UE performs a cell reselection process to the eNB cell for NSA mode via at least FR2. However, if it is ascertained in block 620 that the neighboring eNB cell does not have a higher rank than the gNB serving cell, in this example process 600 reverts to block 605.

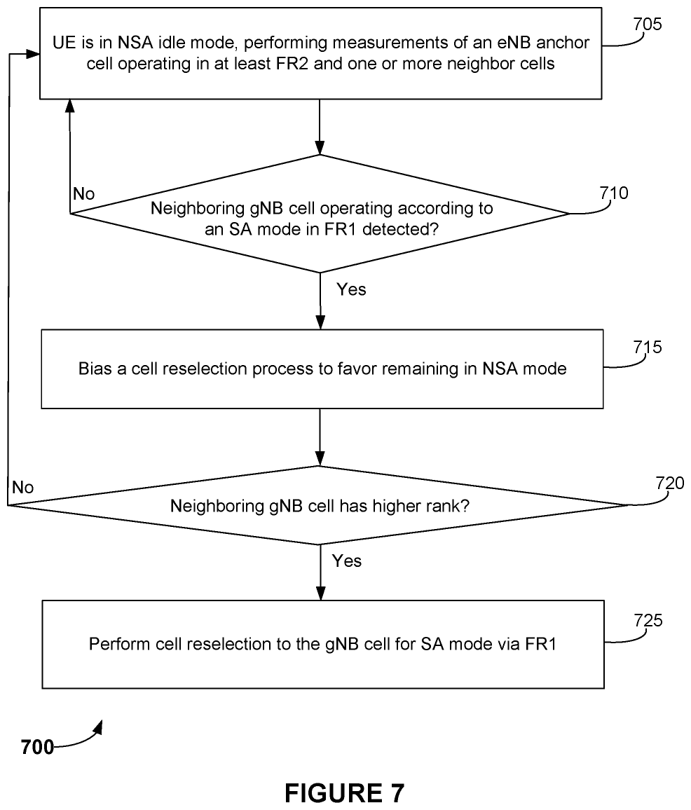

FIG. 7 is a diagram illustrating an example process 700 involving mobility between SA and NSA modes which may be performed, for example, by a UE. In some such examples, the process 700 may be performed by a UE 115 such as one of those disclosed herein. One or more components of the UE 115 may be an example of one or more components of a UE 115, such as illustrated by and described with reference to FIG. 1, 2 or 4A-5E. Although FIG. 7 shows example blocks of the process 700, in some aspects, the process 700 may include additional blocks, fewer blocks, different blocks, or differently arranged blocks than those depicted in FIG. 7. Additionally, or alternatively, in some examples two or more of the blocks of the process 700 may be performed in parallel. The process 700 may include additional aspects, such as any single aspect or any combination of aspects described herein or in connection with one or more other processes described elsewhere herein.

According to this example, in block 705 the UE is in an NSA idle mode, performing measurements of an anchor cell operating in at least a second frequency band, FR2. In this example, the anchor cell is an eNB cell, for example as described herein with reference to FIGS. 5A-5C. However, in some other examples, the serving cell may be another type of anchor cell, such as described herein with reference to FIGS. 5D and 5E. According to the example in block 705, the UE is performing measurements of one or more neighbor cells.

In this example, block 710 involves receiving an indication of whether a neighboring cell (in this particular example, a neighboring gNB cell) is operating according to an SA mode in at least a first frequency band, FRE In this implementation, if the UE receives an indication in block 710 that no neighboring cell is operating according to an SA mode in at least FR1, the process 700 reverts to block 705. However, if the UE receives an indication in block 710 that a neighboring gNB cell is operating according to an SA mode in at least FR1, the process 700 continues to block 715. In some examples, block 710 (or another block of process 700) also may involve receiving an indication of whether the FR1 signals have an acceptable signal strength level.

According to this example, block 715 involves biasing a cell reselection process to favor remaining in NSA mode by remaining camped on the eNB anchor cell. In some implementations, block 715 may involve increasing a priority of an eNB cell type. According to some examples, block 715 may involve increasing a priority of NSA mode. In some implementations, block 715 may involve adding an offset for signal strength measurements of the eNB serving cell. According to some examples, block 715 may involve subtracting an offset for signal strength measurements of the neighboring gNB cell.

In this example, block 720 involves ascertaining whether the neighboring gNB cell has a higher rank than the eNB serving cell. If so, in block 725 the UE performs a cell reselection process to the gNB cell for SA mode via at least FRE However, if it is ascertained in block 720 that the neighboring gNB cell does not have a higher rank than the eNB serving cell, in this example process 700 reverts to block 705.

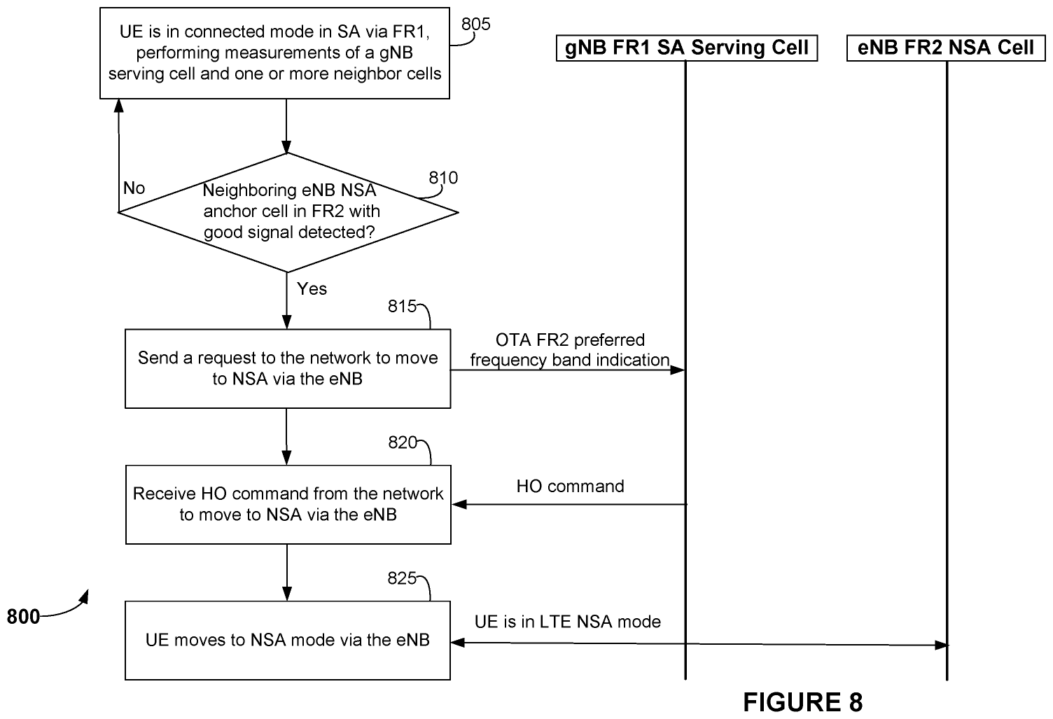

FIG. 8 is a diagram illustrating another example process involving mobility between SA and NSA modes. In some examples, the process 800 may be performed in part by a UE 115 and in part by a BS 105, such as those disclosed herein. For example, one or more components of the UE 115 may be an example of one or more components of a UE 115, such as illustrated by and described with reference to FIG. 1, 2 or 4A-5E. One or more components of the BS 105 may be an example of one or more components of a BS 105 such as illustrated by and described with reference to FIG. 1, or an example of one or more components of a BS 105a or a BS 105b, such as illustrated by and described with reference to FIG. 2. According to this example, the BS 105j is, or includes, a gNB. In some examples, the BS 105j may be an instance of the BS 105a illustrated by and described with reference to FIG. 2, an instance of the BS 105d illustrated by and described with reference to FIG. 4B, an instance of the BS 105g illustrated by and described with reference to FIGS. 5A-5C or an instance of the BS 105i illustrated by and described with reference to FIGS. 5D and 5E. In this example, the BS 105k is, or includes, an eNB. According to some examples, the BS 105k may be an instance of the BS 105b illustrated by and described with reference to FIG. 2, an instance of the BS 105f illustrated by and described with reference to FIGS. 5A-5C or an instance of BS 105h illustrated by and described with reference to FIGS. 5D and 5E. Although FIG. 8 shows example blocks of the process 800, in some aspects, the process 800 may include additional blocks, fewer blocks, different blocks, or differently arranged blocks than those depicted in FIG. 8. Additionally, or alternatively, in some examples two or more of the blocks of the process 800 may be performed in parallel. The process 800 may include additional aspects, such as any single aspect or any combination of aspects described herein or in connection with one or more other processes described elsewhere herein. For example, in some implementations one or more functions that are described herein as being performed by a base station may be performed by a network entity, which may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC.

According to this example, in block 805 a UE is in a 5G SA connected mode with a serving cell. For example, the UE may be providing a video via a streaming service, may be in use for playing a video game, etc. In this example, block 805 also involves performing measurements of a serving cell operating in at least a first frequency band, FRE In this example, the serving cell is a gNB cell, for example as described herein with reference to FIG. 4B. However, in some other examples, the serving cell may be another type of serving cell. According to the example in block 805, the UE is also performing measurements of one or more neighbor cells.

In this example, block 810 involves receiving an indication of whether a neighboring cell (in this particular example, a neighboring eNB cell) is operating according to an NSA mode in at least a second frequency band, FR2. According to this example, block 810 also involves receiving an indication of whether a neighboring eNB anchor cell that is operating according to an NSA mode has a satisfactory signal level in the FR2 frequency band. If not, the process 800 reverts to block 805. However, if the UE receives an indication in block 810 that a neighboring eNB anchor cell that is operating according to an NSA mode has a satisfactory signal level in the FR2 frequency band, the process 800 continues to block 815.

According to this example, block 815 involves sending a request to the network to move the UE to NSA mode and to connect with the eNB anchor cell. In this example, the request is sent as an Over the Air (OTA) signal to the gNB serving cell. The request may be, or may include, be a request for connection with the eNB anchor cell. In the example shown in FIG. 8 the request includes an indication that FR2 is a preferred frequency band.

In this example, block 820 involves receiving a handover (HO) command from the network, via the gNB serving cell, for the UE to move to NSA mode and to connect with the eNB anchor cell. According to this example, in block 825 the UE moves to NSA mode and connects with the eNB anchor cell. In some implementations, the UE first moves to LTE and subsequently the network adds an NR bearer. In some examples, the gNB cell referenced in block 805, which had been a serving cell, becomes a secondary gNB cell for the NSA mode.

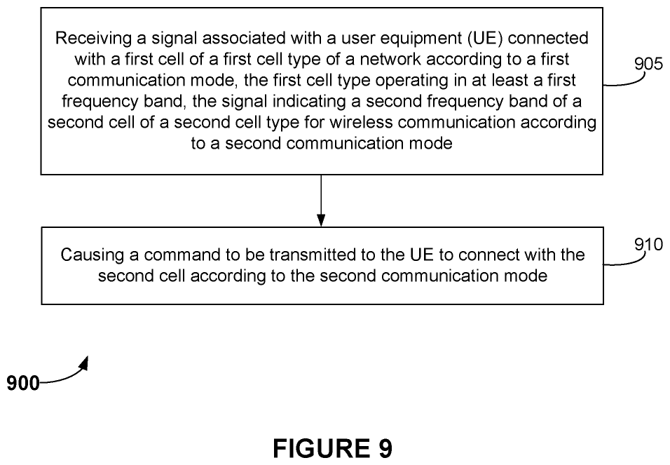

FIG. 9 is a diagram illustrating an example process 900 which may be performed by a network entity. In some such examples, the process 900 may be performed (at least in part) by a BS 105 such as one of those disclosed herein. One or more components of the BS 105 may be an example of one or more components of a BS 105 such as illustrated by and described with reference to FIG. 1, or an example of one or more components of a BS 105a or a BS 105b, such as illustrated by and described with reference to FIG. 2. In some examples, the BS 105 may be, or may include, a gNB. In some examples, the BS 105 may be an instance of the BS 105a illustrated by and described with reference to FIG. 2, an instance of the BS 105d illustrated by and described with reference to FIG. 4B, an instance of the BS 105g illustrated by and described with reference to FIGS. 5A-5C, an instance of the BS 105i illustrated by and described with reference to FIGS. 5D and 5E, or an instance of the BS 105j (the “gNB FR1 SA serving cell”) illustrated by and described with reference to FIG. 8. In some implementations, the network entity may be implemented in a disaggregated base station architecture. According to some such implementations, the network entity may be, or may include, one or more of a CU, a DU, an RU, a Near-RT RIC, or a Non-RT RIC. Although FIG. 9 shows example blocks of the process 900, in some aspects, the process 900 may include additional blocks, fewer blocks, different blocks, or differently arranged blocks than those depicted in FIG. 9. Additionally, or alternatively, in some examples two or more of the blocks of the process 900 may be performed in parallel. The process 900 may include additional aspects, such as any single aspect or any combination of aspects described herein or in connection with one or more other processes described elsewhere herein.

According to this example, block 905 involves receiving a signal associated with a UE connected with a first cell of a first cell type of a network according to a first communication mode. Block 905 may involve receiving the signal directly or indirectly from the UE. For example, the signal may be directly received by an RU. Block 905 may, in some examples, involve the receipt of the signal by another network entity from the RU, in some instances via a fronthaul link. In this example, the first cell type is operating in at least a first frequency band. According to some examples, the first communication mode may be an SA mode. The first cell type may, in some implementations, be a gNB. In some examples, the first frequency band may be FRE

According to this example, the signal received from the UE indicates a second frequency band of a second cell of a second cell type for wireless communication according to a second communication mode. In some examples, the second communication mode may be an LTE and NR NSA mode. The second cell type may, in some implementations, be an eNB. According to some examples, the second frequency band may include higher frequencies than the first frequency band. In some examples, the second frequency band may be FR2.

In some implementations, the request may be a request to move the UE to NSA mode and to connect with an eNB anchor cell. In some examples, the request may be, or may include, an OTA signal. The request may be, or may include, an indication that FR2 is a preferred frequency band, that NSA is a preferred communication mode, or a combination thereof.

In this example, block 910 involves causing a command to be transmitted to the UE to connect with the second cell according to the second communication mode. In some examples, block 910 may involve transmission of the command by a network entity, whereas in other examples block 910 may involve one network entity causing another network entity (such as an RU) to transmit the command According to some examples, the command may be an HO command, as described with reference to FIG. 8. The command may be associated with receiving an indication from the UE that the signals from the second cell are at an acceptable signal strength level. In some examples, the UE may connect with the second cell according to the second communication mode, as described with reference to FIG. 8.

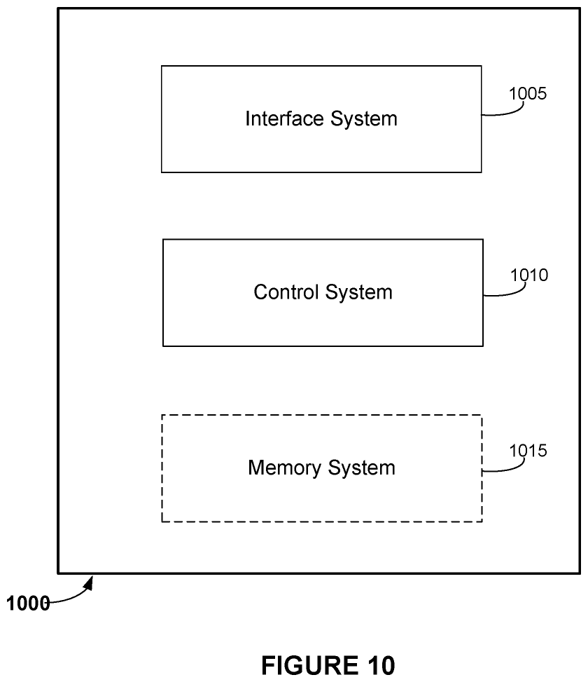

FIG. 10 shows a block diagram of an example apparatus 1000 that supports mobility between NR SA and NSA modes. In some examples the apparatus 1000 maybe a UE, such as one of the UEs 115 disclosed herein. In other examples the apparatus 1000 maybe a BS, such as one of the BSs 105 disclosed herein. In this example, the apparatus 1000 includes an interface system 1005 and a control system 1010. In some examples, the apparatus 1000 may include a memory system 1015 that is separate from, but configured for communication with, the control system 1010.

In this example, the interface system 1005 includes a wireless interface system configured for communication with other devices. In some implementations, the wireless interface system may include a single antenna. However, in some other implementations, the wireless interface system may include more than one antenna, which may be capable of concurrently transmitting or receiving multiple wireless transmissions.

In some examples, the wireless interface system may include a transceiver. In some implementations, the transceiver may communicate bi-directionally, via the one or more antennas, wired, or wireless links as described herein. For example, the transceiver may represent a wireless transceiver and may communicate bi-directionally with another wireless transceiver. The transceiver also may include a modem to modulate the packets, to provide the modulated packets to one or more antennas for transmission, and to demodulate packets received from the one or more antennas. Accordingly, while the control system 1010 and the interface system 1005 are shown as separate elements in FIG. 10, in some implementations the interface system 1005 may include some elements of the control system 1010, or vice versa.

In some implementations, the transceiver may include one or more interfaces, such as one or more interfaces coupled with the one or more antennas that are configured to support various receiving or obtaining operations, or one or more interfaces coupled with the one or more antennas that are configured to support various transmitting or outputting operations, or a combination thereof. In some implementations, the transceiver may include or be configured for coupling with one or more processors or memory components that are operable to perform or support operations based on or associated with received or obtained information or signals, or to generate information or other signals for transmission or other outputting, or any combination thereof. In some implementations, the transceiver, or the transceiver and the one or more antennas, or the transceiver and the one or more antennas and one or more processors or memory components, may be included in a chip or chip assembly that is installed in the apparatus 1000.

In some implementations, the interface system 1005 may include a user interface system, one or more network interfaces, one or more interfaces between the control system 1010 and the memory system 1015, one or more external device interfaces (for example, ports or applications processors), or combinations thereof.

The interface system 1005 may be configured to provide communication (which may include wired or wireless communication, electrical communication, radio communication, etc.) between components of the apparatus 1000. In some such examples, the interface system 1005 may be configured to provide communication between components of the control system 1010, for example via electrically conducting material (for example, via conductive metal wires or traces). According to some examples, the interface system 1005 may be configured to provide communication between the apparatus 1000 and human beings. In some such examples, the interface system 1005 may include one or more user interfaces. The interface system 1005 may, in some examples, include one or more external device interfaces (such as one or more universal serial bus (USB) interfaces or a serial peripheral interface (SPI)).

The control system 1010 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 1010 also may include one or more memory devices, such as one or more random access memory (RAM) devices, read-only memory (ROM) devices, etc. In this example, the control system 1010 is configured for communication with, and for controlling, at least some components of the interface system 1005. In implementations where the apparatus includes a memory system 1015 that is separate from the control system 1010, the control system 1010 also may be configured for communication with the memory system 1015.

The control system 1010 may include components for bi-directional voice and data communications, such as components for transmitting and receiving communications. In some implementations, the control system 1010 may include a communications manager and an input/output (I/O) controller.

The I/O controller may manage input and output signals for the apparatus 1000.

The I/O controller also may manage peripherals not integrated into the apparatus 1000. In some implementations, the I/O controller may represent a physical connection or port to an external peripheral. In some implementations, the I/O controller may utilize an operating system such as iOS®, ANDROID®, MS-DOS®, MS-WINDOWS®, OS/2®, UNIX®, LINUX®, or another known operating system. Additionally, or alternatively, the I/O controller may represent or interact with a modem, a keyboard, a mouse, a touchscreen, or a similar device. In some implementations, the I/O controller may be implemented as part of a processor or processing system. In some implementations, a user may interact with the apparatus 1000 via the I/O controller or via hardware components controlled by the I/O controller.

The communications manager (or one of more other components of the control system 1010) may support wireless communication at a UE in accordance with examples as disclosed herein. For example, the communications manager (or one of more other components of the control system 1010) may be configured to support mobility between NR SA and NSA modes.

In some examples, the memory system 1015 may include one or more memory devices, such as one or more RAM devices, ROM devices, etc. In some implementations, the memory system 1015 may include one or more computer-readable media, or storage media. Computer-readable media include both computer storage media and communication media including any medium that may be enabled to transfer a computer program from one place to another. Storage media may be any available media that may be accessed by a computer. In some examples, the memory system 1015 may include one or more non-transitory media. By way of example, and not limitation, non-transitory media may include RAM, ROM, electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer.

As noted above, in some examples the apparatus 1000 may be a UE. In some such examples, the control system 1010 may be configured for wireless communication via a first cell type of a network according to a first communication mode, the first cell type operating in at least a first frequency band. The control system 1010 also may be configured for wireless communication via a second cell type of the network according to a second communication mode, the second cell type operating in at least a second frequency band.

In some such examples, the control system 1010 may be configured to camp on or wirelessly connect with a first cell of the first cell type via the interface system 1005. In some instances, camping on the first cell may correspond to an idle mode state of the UE according to the first communication mode. In some such examples, the control system 1010 may be configured to control the apparatus 1000 according to a second cell type bias mode, associated with an indication that the apparatus 1000 is within a coverage area of a second cell of the second cell type. The second cell type bias mode may correspond with a bias favoring the second communication mode.

In some instances, the UE may be camped on the first cell of the first cell type. In some such examples, the second cell type bias mode may involve biasing a cell reselection process to favor reselection of the second cell type. In some examples, biasing the cell reselection process may involve increasing a priority of the second cell type. In some implementations, biasing the cell reselection process may involve adding an offset for signal strength measurements of the second cell type. In some examples, the control system may be further configured to reselect the second cell according to the cell reselection process.

In some implementations, the first communication mode may be an NR SA mode and the second communication mode may be an LTE and NR NSA mode. In some examples, the second cell type may be an LTE eNB cell type associated with the second communication mode using the second frequency band and the first cell type may be an NR gNB cell type associated with the first communication mode using the first frequency band.

In some instances, the UE may be wirelessly connected with the first cell. For example, the UE may be in a connected mode state according to the first communication mode. In some such examples, the second cell type bias mode may involve sending a request, via the interface system, to the network for connection with the second cell or the second cell type. In some examples, sending the signal may be associated with a second frequency band channel condition being at or above a threshold level. According to some examples, the second cell type bias mode may involve sending a signal, via the interface system, to the network indicating that the second frequency band is a preferred frequency band. In some such examples, the signal may be an over-the-air (OTA) signal. According to some such implementations, the control system may be further configured to receive, via the interface system, a command from the network for the UE to connect with the second cell via the second communication mode and to connect, via the interface system, with the second cell via the second communication mode.

In some implementations, the control system may be configured to camp on the second cell according to the second communication mode. For example, the control system may be configured to camp on the second cell according to an idle mode state of the second communication mode. According to some such examples, the second cell type bias mode may involve biasing a cell reselection process to favor remaining in the second communication mode. Biasing the cell reselection process may involve increasing a priority of the second cell type, adding an offset for signal strength measurements of the second cell type, subtracting an offset for signal strength measurements of the first cell type, or combinations thereof.

Implementation examples are described in the following numbered clauses:

1. A user equipment (UE), including: an interface system; and a control system coupled to the interface system and configurable for wireless communication via: a first cell type of a network according to a first communication mode, the first cell type operating in at least a first frequency band, and a second cell type of the network according to a second communication mode, the second cell type operating in at least a second frequency band, the control system being further configured to: camp on or wirelessly connect with a first cell of the first cell type via the interface system; and control the UE according to a second cell type bias mode, associated with an indication that the UE is within a coverage area of a second cell of the second cell type, the second cell type bias mode corresponding with a bias favoring the second communication mode.

2. The UE of clause 1, where the UE is camped on the first cell of the first cell type and where the second cell type bias mode involves biasing a cell reselection process to favor reselection of the second cell type.

3. The UE of clause 2, where biasing the cell reselection process involves increasing a priority of the second cell type.

4. The UE of clause 2 or clause 3, where biasing the cell reselection process involves adding an offset for signal strength measurements of the second cell type or subtracting an offset for signal strength measurements of the first cell type.

5. The UE of any one of clauses 2-4, where the control system is further configured to reselect the second cell according to the cell reselection process.

6. The UE of any one of clauses 1-5, where the first communication mode is a New Radio (NR) standalone (SA) mode and the second communication mode is a Long Term Evolution (LTE) and NR non-standalone (NSA) mode.

7. The UE of clause 6, where the second cell type is an LTE evolved nodeB (eNB) cell type associated with the second communication mode using the second frequency band and the first cell type is an NR gNB cell type associated with the first communication mode using the first frequency band.

8. The UE of any one of clauses 1-7, where camping on the first cell corresponds to an idle mode state of the UE according to the first communication mode.

9. The UE of any one of clauses 1, 6 or 7, where the UE is wirelessly connected with the first cell and where the second cell type preferred mode involves sending a request, via the interface system, to the network for connection with the second cell or the second cell type.

10. The UE of any one of clauses 1, 6 or 7, where the UE is connected with the first cell and where the second cell type bias mode involves sending a signal, via the interface system, to the network indicating that the second frequency band is a preferred frequency band.

11. The UE of clause 10, where the signal includes an over-the-air (OTA) signal.

12. The UE of clause 11, where the control system is further configured to: receive, via the interface system, a command from the network for the UE to connect with the second cell via the second communication mode; and connect, via the interface system, with the second cell via the second communication mode.

13. The UE of any one of clauses 10-12, where sending the signal is associated with a second frequency band channel condition being at or above a threshold level.

14. The UE of clause 1, where the control system is further configured to camp on the second cell according to the second communication mode and where the second cell type bias mode involves biasing a cell reselection process to favor remaining in the second communication mode.

15. The UE of clause 14, where biasing the cell reselection process involves increasing a priority of the second cell type or adding an offset for signal strength measurements of the second cell type.

16. A method for wireless communication at a network entity, including: receiving a signal associated with a UE connected with a first cell of a first cell type of a network according to a first communication mode, the first cell type operating in at least a first frequency band, the signal indicating a second frequency band of a second cell of a second cell type for wireless communication according to a second communication mode; and causing a command to be transmitted to the UE to connect with the second cell according to the second communication mode.

17. The method of clause 16, where the signal includes an over-the-air (OTA) signal.

18. The method of clause 16 or clause 17, where the first communication mode is a New Radio (NR) standalone (SA) mode and the second communication mode is a Long Term Evolution (LTE) and NR non-standalone (NSA) mode.

19. The method of any one of clauses 16-18, where the second cell type is an LTE evolved nodeB (eNB) cell type associated with the second communication mode using the second frequency band and the first cell type is an NR gNB cell type associated with the first communication mode using the first frequency band.

20. The method of any one of clauses 16-19, where the second frequency band includes higher frequencies than the first frequency band.

21. A method for wireless communication, including: camping on or wirelessly connecting, via a UE, with a first cell of a first cell type of a network according to a first communication mode, the first cell type operating in at least a first frequency band; and controlling the UE according to a second cell type bias mode, associated with an indication that the UE is within a coverage area of a second cell of a second cell type of the network, the second cell type operating in at least a second frequency band and according to a second communication mode, the second cell type bias mode corresponding with a bias favoring the second communication mode.

22. The method of clause 21, where the UE is camped on the first cell of the first cell type and where the second cell type bias mode involves biasing a cell reselection process to favor reselection of the second cell type.

23. The method of clause 22, where biasing the cell reselection process involves increasing a priority of the second cell type.

24. The method of clause 22 or clause 23, where biasing the cell reselection process involves adding an offset for signal strength measurements of the second cell type or subtracting an offset for signal strength measurements of the first cell type.

25. The method of any one of clauses 22-24, further including reselecting the second cell according to the cell reselection process.

26. The method of any one of clauses 21-25, where: the first communication mode is a New Radio (NR) standalone (SA) mode; the second communication mode is a Long Term Evolution (LTE) and NR non-standalone (NSA) mode; the second cell type is an LTE evolved nodeB (eNB) cell type associated with the second communication mode using the second frequency band; and the first cell type is an NR gNB cell type associated with the first communication mode using the first frequency band.

27. The method of clause 21, where camping on the first cell corresponds to an idle mode state of the UE according to the first communication mode.

28. The method of clause 21, where the UE is wirelessly connected with the first cell and where the second cell type bias mode involves sending a request to the network for connection with the second cell or the second cell type.

29. A UE, including: means for camping on or wirelessly connecting with a first cell of a first cell type of a network according to a first communication mode, the first cell type operating in at least a first frequency band; and means for controlling the UE according to a second cell type bias mode, associated with an indication that the UE is within a coverage area of a second cell of a second cell type of the network, the second cell type operating in at least a second frequency band and according to a second communication mode, the second cell type bias mode corresponding with a bias favoring the second communication mode.

30. The UE of clause 29, where the UE is camped on the first cell of the first cell type and where the second cell type bias mode involves biasing a cell reselection process to favor reselection of the second cell type.

As used herein, the term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described herein as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. A user equipment (UE), comprising:
an interface system; and
a control system coupled to the interface system and configurable for wireless communication via:
a first cell type of a network according to a first communication mode, the first cell type operating in at least a first frequency band, and
a second cell type of the network according to a second communication mode, the second cell type operating in at least a second frequency band, the control system being further configured to:
camp on or wirelessly connect with a first cell of the first cell type via the interface system; and
control the UE according to a second cell type bias mode, associated with an indication that the UE is within a coverage area of a second cell of the second cell type, the second cell type bias mode corresponding with a bias favoring the second communication mode.

2. The UE of claim 1, wherein the UE is camped on the first cell of the first cell type and wherein the second cell type bias mode involves biasing a cell reselection process to favor reselection of the second cell type.

3. The UE of claim 2, wherein biasing the cell reselection process involves increasing a priority of the second cell type.

4. The UE of claim 2, wherein biasing the cell reselection process involves adding an offset for signal strength measurements of the second cell type or subtracting an offset for signal strength measurements of the first cell type.

5. The UE of claim 2, wherein the control system is further configured to reselect the second cell according to the cell reselection process.

6. The UE of claim 1, wherein the first communication mode is a New Radio (NR) standalone (SA) mode and the second communication mode is a Long Term Evolution (LTE) and NR non-standalone (NSA) mode.

7. The UE of claim 6, wherein the second cell type is an LTE evolved nodeB (eNB) cell type associated with the second communication mode using the second frequency band and the first cell type is an NR gNB cell type associated with the first communication mode using the first frequency band.

8. The UE of claim 1, wherein camping on the first cell corresponds to an idle mode state of the UE according to the first communication mode.

9. The UE of claim 1, wherein the UE is wirelessly connected with the first cell and wherein the second cell type preferred mode involves sending a request, via the interface system, to the network for connection with the second cell or the second cell type.

10. The UE of claim 1, wherein the UE is connected with the first cell and wherein the second cell type bias mode involves sending a signal, via the interface system, to the network indicating that the second frequency band is a preferred frequency band.

11. The UE of claim 10, wherein the signal comprises an over-the-air (OTA) signal.

12. The UE of claim 11, wherein the control system is further configured to:
receive, via the interface system, a command from the network for the UE to connect with the second cell via the second communication mode; and
connect, via the interface system, with the second cell via the second communication mode.

13. The UE of claim 10, wherein sending the signal is associated with a second frequency band channel condition being at or above a threshold level.

14. The UE of claim 1, wherein the control system is further configured to camp on the second cell according to the second communication mode and wherein the second cell type bias mode involves biasing a cell reselection process to favor remaining in the second communication mode.

15. The UE of claim 14, wherein biasing the cell reselection process involves increasing a priority of the second cell type or adding an offset for signal strength measurements of the second cell type.

16. A method for wireless communication at a network entity, comprising:
receiving a signal associated with a user equipment (UE) connected with a first cell of a first cell type of a network according to a first communication mode, the first cell type operating in at least a first frequency band,
the signal indicating a second frequency band of a second cell of a second cell type for wireless communication according to a second communication mode; and
causing a command to be transmitted to the UE to connect with the second cell according to the second communication mode.

17. The method of claim 16, wherein the signal comprises an over-the-air (OTA) signal.

18. The method of claim 16, wherein the first communication mode is a New Radio (NR) standalone (SA) mode and the second communication mode is a Long Term Evolution (LTE) and NR non-standalone (NSA) mode.

19. The method of claim 16, wherein the second cell type is an LTE evolved nodeB (eNB) cell type associated with the second communication mode using the second frequency band and the first cell type is an NR gNB cell type associated with the first communication mode using the first frequency band.
The method of claim 16, wherein the second frequency band includes higher frequencies than the first frequency band.

21. A method for wireless communication, comprising:
camping on or wirelessly connecting, via a user equipment (UE), with a first cell of a first cell type of a network according to a first communication mode, the first cell type operating in at least a first frequency band; and
controlling the UE according to a second cell type bias mode, associated with an indication that the UE is within a coverage area of a second cell of a second cell type of the network, the second cell type operating in at least a second frequency band and according to a second communication mode, the second cell type bias mode corresponding with a bias favoring the second communication mode.

22. The method of claim 21, wherein the UE is camped on the first cell of the first cell type and wherein the second cell type bias mode involves biasing a cell reselection process to favor reselection of the second cell type.

23. The method of claim 22, wherein biasing the cell reselection process involves increasing a priority of the second cell type.

24. The method of claim 22, wherein biasing the cell reselection process involves adding an offset for signal strength measurements of the second cell type or subtracting an offset for signal strength measurements of the first cell type.

25. The method of claim 22, further comprising reselecting the second cell according to the cell reselection process.

26. The method of claim 21, wherein:
the first communication mode is a New Radio (NR) standalone (SA) mode;
the second communication mode is a Long Term Evolution (LTE) and NR non-standalone (NSA) mode;
the second cell type is an LTE evolved nodeB (eNB) cell type associated with the second communication mode using the second frequency band; and
the first cell type is an NR gNB cell type associated with the first communication mode using the first frequency band.

27. The method of claim 21, wherein camping on the first cell corresponds to an idle mode state of the UE according to the first communication mode.

28. The method of claim 21, wherein the UE is wirelessly connected with the first cell and wherein the second cell type bias mode involves sending a request to the network for connection with the second cell or the second cell type.

29. A user equipment (UE), comprising:
means for camping on or wirelessly connecting with a first cell of a first cell type of a network according to a first communication mode, the first cell type operating in at least a first frequency band; and
means for controlling the UE according to a second cell type bias mode, associated with an indication that the UE is within a coverage area of a second cell of a second cell type of the network, the second cell type operating in at least a second frequency band and according to a second communication mode, the second cell type bias mode corresponding with a bias favoring the second communication mode.

30. The UE of claim 29, wherein the UE is camped on the first cell of the first cell type and wherein the second cell type bias mode involves biasing a cell reselection process to favor reselection of the second cell type.
